(19) United States
(12) Patent Application Publication
(10) Pub. No.: US 2018/0043916 A1
(43) Pub. Date: Feb. 15, 2018

(54) VEHICLE

(71) Applicant: Rolf STROTHMANN, Saarbrücken (DE)

(72) Inventor: Rolf STROTHMANN, Saarbrücken (DE)

(21) Appl. No.: 15/560,959

(22) PCT Filed: Mar. 1, 2016
(86) PCT No.: PCT/DE2016/100090

§ 371 Date: Sep. 22, 2017

(30) Foreign Application Priority Data
Mar. 25, 2015 (DE) 10 2015 104 513.3

(51) Int. Cl. B62B 5/00; H02P 29/40

(52) U.S. Cl. CPC B62B 5/0073; B62B 5/0033; H02P 29/40

(57) ABSTRACT

A vehicle, in particular a vehicle to be propelled by muscular energy. The vehicle includes devices for compensating for forces acting on the vehicle in or against the direction of travel as a result of deviations from defined operating conditions. The vehicle advantageously maintains an unchanged driving behavior corresponding to the operating conditions even when there are deviations from the operating conditions,

The invention relates to a vehicle, in particular to a vehicle which is intended to be driven by muscle power, such as a golf trolley, a baby carriage or a bicycle for example.

According to the invention, the vehicle has devices for compensating for forces which act on the vehicle in or against the direction of travel as a result of deviation from prespecified operating conditions.

The vehicle advantageously maintains its traveling behavior, which corresponds to the defined operating conditions and which the user of the vehicle may be used to and which said user may find to be advantageous, in each traveling situation.

By way of example, the movement of the vehicle in a horizontal plane, the movement of the vehicle in a specific loading state, the movement of the vehicle on solid ground or/and travel in windless conditions may be defined as the operating condition. Downhill slope forces, additional rolling friction forces or air resistance forces which occur as a result of deviation from these conditions are compensated for according to the invention.

In a particularly preferred embodiment, the compensation devices comprise an electrical machine which generates the compensating forces.

In particular, the electrical machine can be operated as a motor with generation of a compensating force in the direction of travel and as a generator with generation of a compensating force against the direction of travel. The electrical machine, when traveling uphill, generates a motor force which compensates for the downhill slope force which is directed backward, and generates a corresponding braking force when traveling downhill.

In particular, the compensation devices comprise means for determining the magnitude of the compensating forces in real time and for automatically setting the compensating forces on the basis of the ascertained force values. Setting is performed in real time in such a way that the user does not notice, for example, downhill slope forces or even the change therein at all.

In one embodiment, the means for determining the magnitude of forces which are to be compensated for comprise a position sensor for determining inclinations of the vehicle with respect to the horizontal.

A control device can ascertain the respective downhill slope force on the basis of signals from the position sensor given a known vehicle mass.

Furthermore, the means can comprise an acceleration sensor. If the total mass of the vehicle deviates from the known mass value as a result of loading, the vehicle mass can be ascertained by deliberate application of a specific force to the vehicle by the electrical machine and by measuring the acceleration, wherein the downhill slope force to be respectively compensated for can be determined from mass and inclination.

The electrical machine expediently generates a defined force/time function. A force/time function of this kind can include oscillating application of a drive force, wherein both the vehicle mass and the rolling friction forces can be ascertained by evaluating the resulting acceleration/time behavior.

In a further embodiment of the invention, the electrical machine can be a constituent part of an auxiliary drive which assists the operation by muscle drive force in addition to the compensation according to the invention.

The invention will be explained further below with reference to exemplary embodiments and the accompanying drawings which relate to these exemplary embodiments and in which:

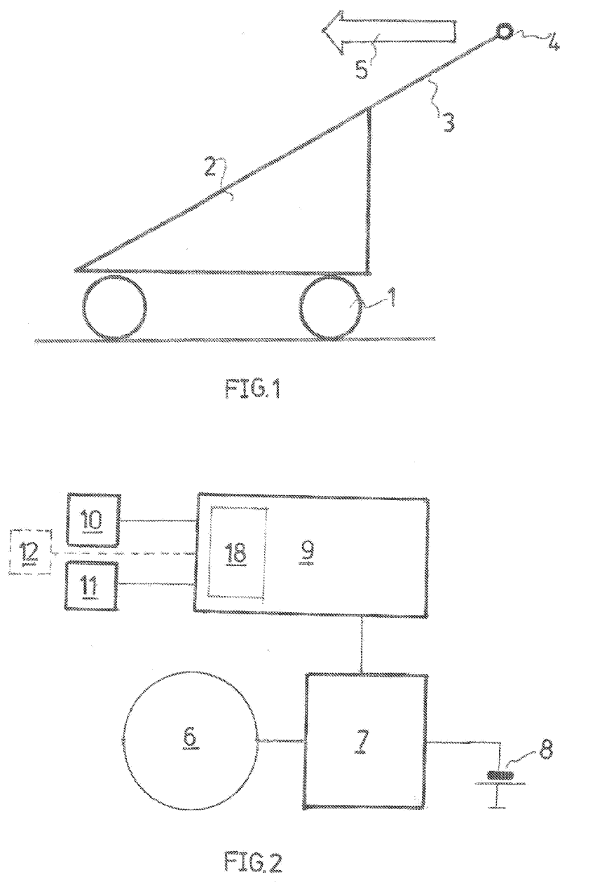

FIG. 1 shows a side view of a vehicle according to the invention,

FIG. 2 shows a schematic illustration of a compensation device according to the invention used in the vehicle of FIG. 1, and

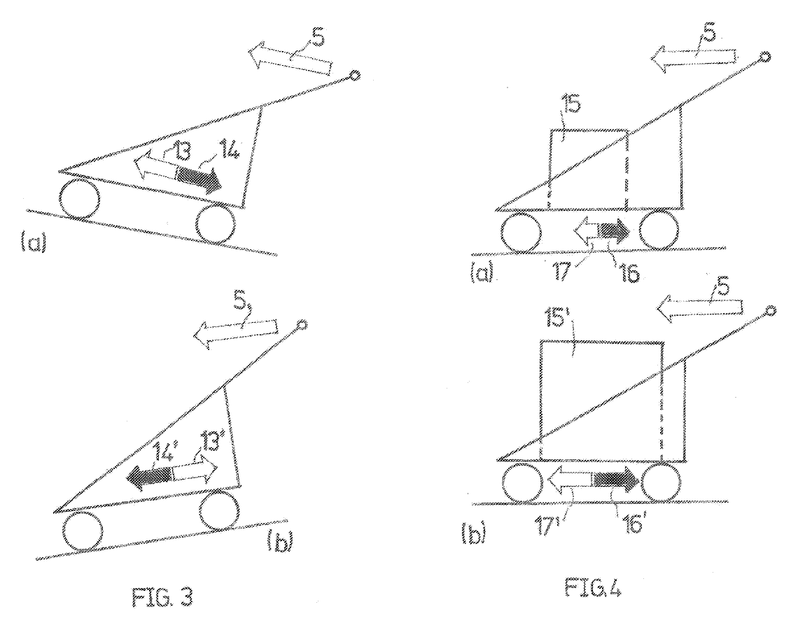

FIGS. 3 and 4 show illustrations explaining the operation of the apparatus according to the invention from FIG. 1.

A vehicle which is intended to be driven by muscle power and has wheels 1 and a loading region 2 comprises a push/pull rod 3 with a handle 4. A pushing force can be exerted on the handle 4, for example in the direction of travel, in accordance with arrow 5. The vehicle is, for example, a golf trolley or a baby carriage.

According to FIG. 2, the vehicle shown in FIG. 1 comprises an electrical machine 6 which is preferably accommodated in one of the wheels 1. Instead of a single electrical machine, a plurality of machines of this kind, in particular a machine of this kind accommodated in each one of the wheels 1, could be provided. The electrical machine 6 is connected to a rechargeable battery 8 by means of a power control device 7.

As can be further inferred from FIG. 2, the power control device 7 is connected to a central controller 9 which comprises a computer 18. The controller 9, for its part, is connected to a position sensor 10, which detects inclinations of the vehicle in relation to the vertical, and to a distance-of-travel sensor 11. As indicated by dashed lines, a force sensor 12 can further be connected to the central controller 9, which force sensor measures muscle drive forces which are exerted on the handle 4 and which force sensor may be integrated in the handle, for example.

Under defined operating conditions which, in the described example, involve the user moving the vehicle on horizontal, level ground in an unloaded state, the electrical machine 6 shown in FIG. 2 remains inactive. The machine 6 comes into use only in the event of deviation from these operating conditions, that is to say when the vehicle is moving uphill or downhill or/and when the vehicle is loaded.

According to FIG. 3a, the electrical machine 6 acts as a motor when traveling uphill and respectively generates a force 13 in the direction of travel, which force specifically cancels out the downhill slope force 14 which acts against the direction of travel. When traveling downhill according to FIG. 3b, the electrical machine operates as a generator and generates a generator braking force 13′ which compensates for the downhill slope force 14′ acting in the direction of travel.

An additional rolling friction force 16 which is generated, for example, by loading with a load 15 is compensated for according to FIG. 4a by a force 17 of the electrical machine 6 which acts as a motor. In the case of a further increased load 15′, a compensation force 17′ which is increased in accordance with the increased additional rolling friction force 16′ is generated.

Before automatic setting of the respective compensation force which is to be generated by the electrical machine 6, the central controller 9 receives the signal from the position sensor 10. In the case of an unloaded vehicle and known total mass of the vehicle, the computer 18 calculates the respectively required compensation force and the central controller 9 transmits corresponding control signals to the power control device 7 which ensures a corresponding current supply to the electrical machine 6 and, for example, applies the voltage of the rechargeable battery 8 to several phases of the electrical machine 6 in accordance with the pulse-width-modulation process. When traveling uphill and downhill, the vehicle behaves as though it is traveling on a level surface and rolls as it would on a level surface if the user lets go of the vehicle.

If the vehicle is loaded, this therefore has an effect not only, as shown in FIG. 4, on an increase in the rolling friction force, but also directly on the downhill slope force. In order to set the compensation forces in the event of deviation from the unloaded state, it may therefore be necessary to ascertain the respective total mass of the vehicle.

To this end, the central controller 9 ensures that a defined acceleration force is generated by the electrical machine 9 and the computer 18 of the central controller 9 ascertains, from double differentiation of the measurement signal of the distance-of-travel sensor 11, the resulting acceleration. The computer ascertains the respective vehicle mass from the known acceleration force and said acceleration. The downhill slope force to be compensated for in each case can then be ascertained in real time on the basis of the respective vehicle mass and the measurement signal from the position sensor 10.

Furthermore, the respectively acting rolling friction force can be determined from an acceleration signal expediently generated by an oscillating acceleration force, and in this way the corresponding forces, which compensate for the increased rolling friction, of the electrical machine 6 can be set.

A particularly noticeable alleviation would be provided by the above-described compensation-free devices in the case of a bicycle when the user of said bicycle wishes to begin traveling uphill or downhill from a standstill. The strenuous acceleration to achieve the equilibrium state against the backwardly directed downhill slope force is dispensed with. It is possible to begin traveling downhill due to the downhill slope force without interference.

The arrangement shown in FIG. 2 comprising the electrical machine 6, beyond the above-described compensation, can also form an auxiliary drive which assists the operation of the vehicle by muscle power and which ensures that the muscle drive force exerted on the handle 4 and ascertained by the force sensor 12 is amplified by a prespecified factor by the electrical machine by the electrical machine 6. Therefore, drive forces which are reduced by this factor are required, wherein different total masses of the vehicle are nevertheless perceived in the traveling behavior.

It goes without saying that the defined operating conditions can differ from the above-described example and, for example, the movement on an inclined plane can be prespecified. In each case, the compensation devices automatically generate forces which influence the traveling behavior of the vehicle and to which the user of the vehicle can add forces which can be influenced by him.

1-11. (canceled)

12. A vehicle, comprising devices for compensating for forces which act on the vehicle in or against a direction of travel as a result of deviation from defined operating conditions,

13. The vehicle according to claim 12, wherein the vehicle is operable by muscle power.

14. The vehicle according to claim 12, wherein the compensation device comprise an electrical machine which generates compensating forces.

15. The vehicle according to claim 14, wherein the electrical machine is operable as a motor that generates a compensating force in the direction of travel and as a generator that generates a compensating force against the direction of travel.

16. The vehicle according to claim 14, wherein the compensation devices comprise means for determining a magnitude of the forces to be compensated for in real time and for automatically setting compensating forces based on the determined magnitude,.

17. The vehicle according to claim 12, wherein the forces are downhill slope forces or/and rolling friction forces.

18. The vehicle according to claim 12, wherein movements of the vehicle in a horizontal plane or/and movement of the vehicle in an unloaded state is/are defined as an operating condition. (New) The vehicle according to claim 16, wherein the means for determining the magnitude of forces which are to be compensated for include a position sensor for determining inclination of the vehicle,

20. The vehicle according to claim 16, wherein the means for determining the magnitude of forces which are to be compensated for include an acceleration sensor.

21. The vehicle according to claim 16, wherein the means for determining the magnitude of forces to be compensated for generate a specific force/time function by the electrical machine.

22. The vehicle according to claim 14, wherein the electrical machine is a constituent part of an auxiliary drive that assists driving of the vehicle by muscle power.
